(19) United States
(12) Patent Application Publication
(10) Pub. No.: US 2026/0138035 A1
(43) Pub. Date: May 21, 2026

(54) INFORMATION PROCESSING APPARATUS AND COMMENT SENDING METHOD

(71) Applicant: Sony Interactive Entertainment Inc., Tokyo (JP)

(72) Inventor: Tsuyoshi Ono, Tokyo (JP)

(73) Assignee: Sony Interactive Entertainment Inc., Tokyo (JP)

(21) Appl. No.: 19/448,538

(22) Filed: Jan. 14, 2026

Related U.S. Application Data
(63) Continuation of application No. PCT/JP2023/026128, filed on Jul. 14, 2023.

(51) Int. Cl. A63F 13/87; A63F 13/533

(52) U.S. Cl. CPC A63F 13/87; A63F 13/533

(57) ABSTRACT

Apparatuses and methods for sending comments are disclosed. An example information processing apparatus includes one or more processors having hardware, wherein the one or more processors receive a comment to be entered in relation to a play unit performed by a user, and send the comment together with information specifying the performed play unit to a server device.

### CROSS-REFERENCE TO RELATED APPLICATION

This application is a Continuation application under 35 U.S.C. § 111 of International Patent Application No. PCT/JP2023/026128, filed on Jul. 14, 2023, the entire disclosure of which is incorporated herein by reference for all purposes.

### TECHNICAL FIELD

The present disclosure relates to a technique, which allows a user to enter a comment pertaining to a game.

### BACKGROUND

A server device for processing event data relating to activities carried out by a plurality of players is known (see, for example, JP 2022-063756A). This server device acquires the play times of the activities by the plurality of players, classifies the players into any of a plurality of classes depending on skill values of the players, and determines representative values of the play times in the respective classes based on the play times of the plurality of players in the respective classes. The server device notifies, to the user, the estimated play time derived from the representative value of the play time corresponding to the class of the user.

### SUMMARY

There are review websites pertaining to games. After a certain player has ended playing a game, he/she writes game information on a review website, while another player reads the game information in a review website before starting to play a game. The review websites exist on the web and therefore it is necessary to use a terminal device (for example, a smartphone or a tablet) different from the game device used for game playing to access the review websites in order to write and read the game information during game playing. Therefore, the object of the present disclosure is to provide a technique of allowing the player to easily write and read comments pertaining to a game.

An information processing apparatus according to a certain embodiment of the present disclosure includes one or more processors having hardware. The one or more processors receive a comment to be entered in relation to a play unit performed by a user, and send the comment together with information specifying the performed play unit.

An information processing apparatus according to another embodiment of the present disclosure includes the one or more processors having hardware. The one or more processors acquire information in relation to the play unit being performed by the user or the play unit not yet performed by the user, and display, together with the information in relation to the play unit, information indicating that there is a comment generated in relation to the play unit concerned.

A further embodiment of the present disclosure is a method for sending a comment, the method including steps of: receiving the comment to be entered in relation to the play unit performed by a user; and sending the comment together with the information specifying the performed play unit.

Any combination of the above-described constituent elements, and expressions of the present disclosure which were converted among the method, device, system, recording medium, and computer program, etc., are also effective as embodiments of the present disclosure.

### BRIEF DESCRIPTION OF DRAWINGS

FIG. 1 is a drawing showing an information processing system according to an embodiment.

FIG. 2 is a drawing showing a hardware configuration of the information processing apparatus.

FIG. 3 is a drawing showing function blocks of the information processing apparatus.

FIG. 4 is a drawing showing an example of a game screen.

FIG. 5 is a drawing showing function blocks of a server device.

FIG. 6 is a drawing showing an example of a save screen.

FIG. 7 is a drawing showing an example of a system image overlapped and displayed on the save screen.

FIG. 8 is a drawing showing another example of the system image overlapped and displayed on the save screen.

FIG. 9 is a drawing showing another example of the save screen.

FIG. 10 is a drawing showing another example of the save screen.

FIG. 11 is a drawing showing an example of the system image.

FIG. 12 is a drawing showing an example of the system image.

### DETAILED DESCRIPTION

In an embodiment, the information processing apparatus as a user terminal device executes game software. When an event occurs in a game, the game software outputs, to system software, event information identifying the event which occurred. The event occurs when, for example, there are changes in the progress of a game play or changes in the actions of game characters. The game software includes a plurality of play units, for which at least an ending condition is set.

The game software includes, as a kind of play unit, an activity, for which a starting condition and ending condition are set. The activity may be configured from stages, quests, missions, tournaments, and sessions, etc. The activity is appropriately set by game makers and, for example, one quest appearing during a game in progress may constitute one activity, or a plurality of quests may constitute one activity. If a plurality of quests constitutes one activity, completing all of the plurality of quests becomes the ending condition of the activity concerned.

When an activity starts, the game software outputs, to the system software, an activity identifier (activity ID) for identifying the activity, and event information including information indicating the start of the activity. When the activity ends, the game software outputs, to the system software, the activity ID, and event information including information indicating the end of the activity. When the activity ends, the game software may include the result (success or failure) of the activity in the event information. The system software generates event data by adding a user identifier (user account) for identifying the user, a game identifier (game ID) for identifying the game, and time information (time stamp), to the event information outputted from the game software, and sends it to an external server device.

A server device collects the event data sent from a plurality of information processing apparatuses operated by a plurality of players, and analyzes play trends relating to the activities. For example, the server device may statistically derive the play times of the activities by the plurality of players based on the event data sent from the plurality of information processing apparatuses. As disclosed in Patent Literature 1, the server device may classify the players into any of a plurality of classes depending on skill values of the players, and determine representative values of the play times of the activities in the respective classes based on the play times of the plurality of players in the respective classes. The representative values of the play times of the activities corresponding to the classes of the users are used as estimated play times of the users, and the server device may notify the estimated play times derived for the activities concerned, when a user performs a new activity.

The game software sets various quests or missions (hereinafter also referred to as merely “mission”) for acquiring trophies which are virtual awards, as a play unit different from the activities. When the user completes a mission, a trophy corresponding to a mission is given to the user. The ending condition for the mission is a play condition for releasing the trophy to the user and is also called an “unlock condition” for the trophy. A determination for ending the trophy mission is made by the system software determining whether or not, based on event information outputted by the game software, the unlock condition for the trophy has been established. The system software sends acquisition information for the unlocked trophy to the external server device. The server device may collect the trophy acquisition information to be sent from the plurality of information processing apparatuses operated by the plurality of players to analyze the play trends concerning trophy acquisition.

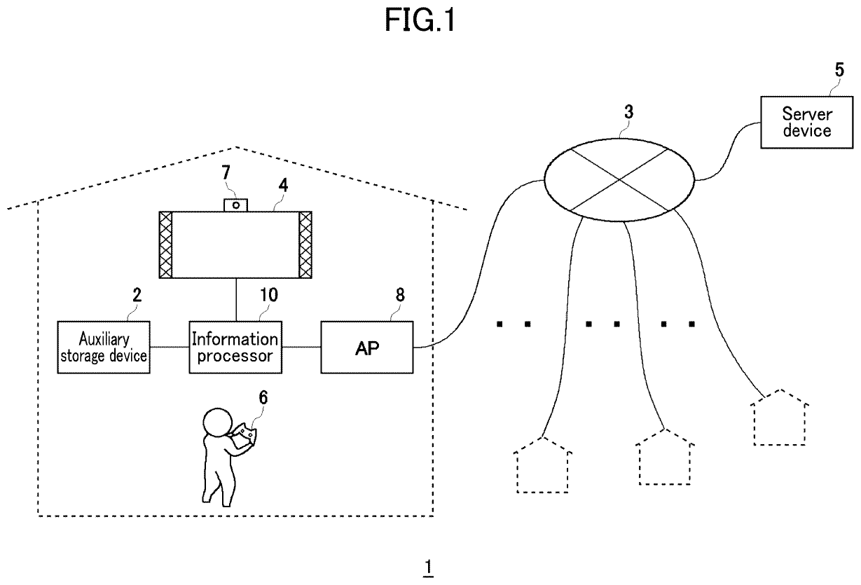

FIG. 1 shows an information processing system 1 according to an embodiment of the present disclosure. The information processing system 1 in the embodiment is a game system for assisting a game play by a user, and includes an information processing apparatus 10 operated by the user who is a player, and a server device 5. An access point (hereinafter referred to as “AP”) 8 has the functions of a wireless access point and a router, and the information processing apparatus 10 is connected to the AP 8 in a wireless or wired manner, so that the information processing apparatus 10 can communicate with the server device 5 on the network 3. FIG. 1 shows one user and one information processing apparatus 10; however, in the information processing system 1, a plurality of information processing apparatuses 10 operated by a plurality of players is presumed to be connected to the server device 5 via the network 3.

The information processing apparatus 10 is connected to an input device 6 operated by the user in a wireless or wired manner, and the input device 6 outputs information based on the operation by the user to the information processing apparatus 10. The information processing apparatus 10 receives operation information from the input device 6 and then reflects it to system software and game software processes, and makes an output device 4 output the process results. In the information processing system 1, the information processing apparatus 10 is a game device (game console) which executes a game, and the input device 6 may be an appliance such as a game controller for supplying the operation information of the user to the information processing apparatus 10. The input device 6 may be an input interface such as a keyboard and a mouse.

An auxiliary storage device 2 is a large-capacity recording device such as an HDD (hard disk drive) and an SSD (solid state drive), may be a built-in-type recording device, and may also be an external recording device to be connected to the information processing apparatus 10 by means of, e.g., a USB (universal serial bus). The output device 4 may be a television having a display outputting images and a speaker outputting sound. The output device 4 may be connected to the information processing apparatus 10 by means of a wire cable or may be connected wirelessly.

A camera 7 as an imaging device is provided in the vicinity of the output device 4 to image the space around the output device 4. FIG. 1 shows an example where the camera 7 is attached to an upper part of the output device 4; however, the camera 7 may be arranged at a side part or a lower part of the output device 4. In any case, the camera 7 is arranged at a position where the user located in front of the output device 4 can be imaged. The camera 7 may be a stereo camera.

The server device 5 provides the user of the information processing system 1 with network service. The server device 5 manages network accounts (user accounts) for identifying the respective users, and the respective users sign into the network service provided by the server device 5, using the network accounts. The user signs into the network service from the information processing apparatus 10, so that the user can register, in the server device 5, save data of the game and trophies which are virtual rewards acquired during the game play. The save data and the trophies are registered in the server device 5, so that, even if the user uses an information processing apparatus different from the information processing apparatus 10, the save data and the trophies can be synchronized.

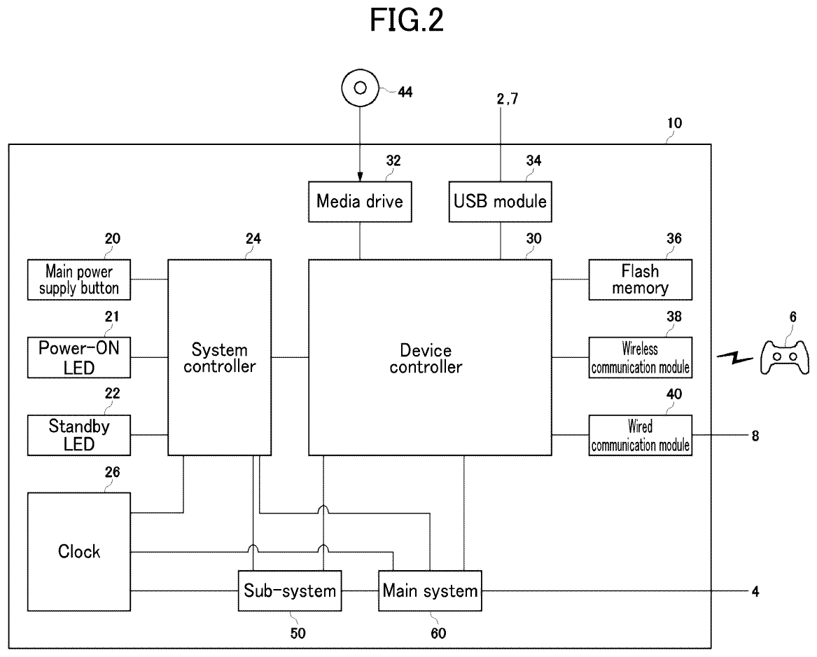

FIG. 2 shows a hardware configuration of the information processing apparatus 10. The information processing apparatus 10 is configured to include a main power supply button 20, a power-ON LED 21, a standby LED 22, a system controller 24, a clock 26, a device controller 30, a media drive 32, a USB module 34, a flash memory 36, a wireless communication module 38, a wired communication module 40, a sub-system 50, and a main system 60.

The main system 60 includes a main CPU (central processing unit), a memory as a main storage device and a memory controller, and a GPU (graphics processing unit), etc. The GPU is mainly used for a calculation process of the game program. The main CPU has the functions of activating the system software, and executing the game program installed in the auxiliary storage device 2 under an environment provided by the system software. The sub-system 50 includes a sub-CPU, the memory as the main storage device, and the memory controller, and does not include the GPU.

The main CPU has a function of executing the game program installed in the auxiliary storage device 2, while the sub-CPU does not have such a function. However, the sub-CPU has a function of accessing the auxiliary storage device 2 as well as a function of sending and receiving the data to and from the server device 5. The sub-CPU is configured to have the above-described limited processing function only, and therefore it can be operated with less consumption electric power compared to the main CPU. These functions of the sub-CPU are executed when the main CPU is in a standby state.

A main power supply button 20 is an input part where an operation is entered by the user, is provided on the front surface of the housing of the information processing apparatus 10, and is operated in order to turn on or off power supply to the main system 60 in the information processing apparatus 10. The power-ON LED 21 is lit when the main power supply button 20 is turned on, and the standby LED 22 is lit when the main power supply button 20 is turned off. The system controller 24 detects a depression of the main power supply button 20 by the user.

A clock 26 is a real-time clock, generates current date and time information, and supplies this information to the system controller 24, the sub-system 50, and the main system 60.

The device controller 30 is configured as an LSI (large-scale integrated circuit), which executes transfer of information between devices such as a southbridge. As illustrated, the following devices are connected to the device controller 30: the system controller 24, the media drive 32, the USB module 34, the flash memory 36, the wireless communication module 38, the wired communication module 40, the sub-system 50, and the main system 60 etc. The device controller 30 absorbs differences between the electric characteristics of the respective devices, differences between the data transfer speeds, as well as controls the timings of the data transfer.

The media drive 32 is a drive device which is driven with a ROM medium 44 fitted thereto, the ROM medium 44 having been recorded with application software such as a game and license information, where the media drive 32 reads a program and data etc. from the ROM medium 44. The ROM medium 44 is a read-only recording medium such as an optical disk, a magneto-optical disk, and a Blu-ray disk.

The USB module 34 is a module to be connected to an external equipment via a USB cable. The USB module 34 may be connected to the auxiliary storage device 2 and the camera 7 via a USB cable. The flash memory 36 is an auxiliary storage device constituting an internal storage. The wireless communication module 38 wirelessly communicates with the input device 6 by means of a communication protocol such as a Bluetooth® protocol and an IEEE802.11 protocol. The wired communication module 40 communicates with the external equipment in a wired manner and is connected to the network 3 via the AP 8.

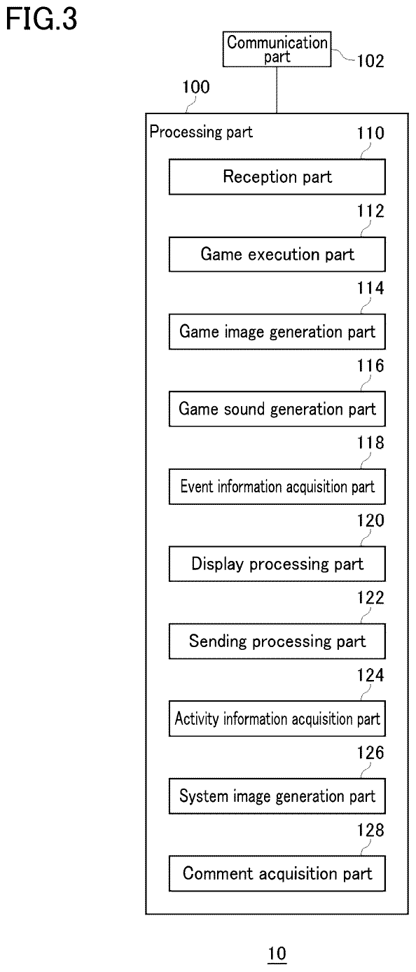

FIG. 3 shows function blocks of the information processing apparatus 10. The information processing apparatus 10 includes a processing part 100 and a communication part 102. The processing part 100 includes a reception part 110, a game execution part 112, a game image generation part 114, a game sound generation part 116, an event information acquisition part 118, a display processing part 120, a sending processing part 122, an activity information acquisition part 124, a system image generation part 126, and a comment acquisition part 128. The system image generation part 126 is realized as one function of the system software. The reception part 110 receives information indicating that the user has operated the input device 6.

The information processing apparatus 10 includes a computer and the computer executes a program, so that the various functions as shown in FIG. 3 are realized. The computer includes, as hardware, a memory for loading the program, one or more processors for executing the loaded program, an auxiliary storage device, and other LSIs, etc. The processor is configured from a plurality of electronic circuits including a semiconductor integrated circuit and LSI, and the plurality of electronic circuits may be either mounted on one chip or on a plurality of chips. The function blocks shown in FIG. 3 are realized in cooperation between the hardware and the software, and thus the skilled person understands that these function blocks are realized in various forms, namely, by the hardware only, by the software only, or by a combination thereof.

The game execution part 112 has a function of activating and executing the game program. The game execution part 112 carries out a calculation process for moving game characters in a virtual space based on the operation information received by the reception part 110. The game image generation part 114 includes a GPU (graphics processing unit) which executes a rendering process etc., and the game image generation part 114 generates image data of the game. The display processing part 120 displays the generated game image on the output device 4. The game sound generation part 116 generates sound data of the game and outputs it from the speaker.

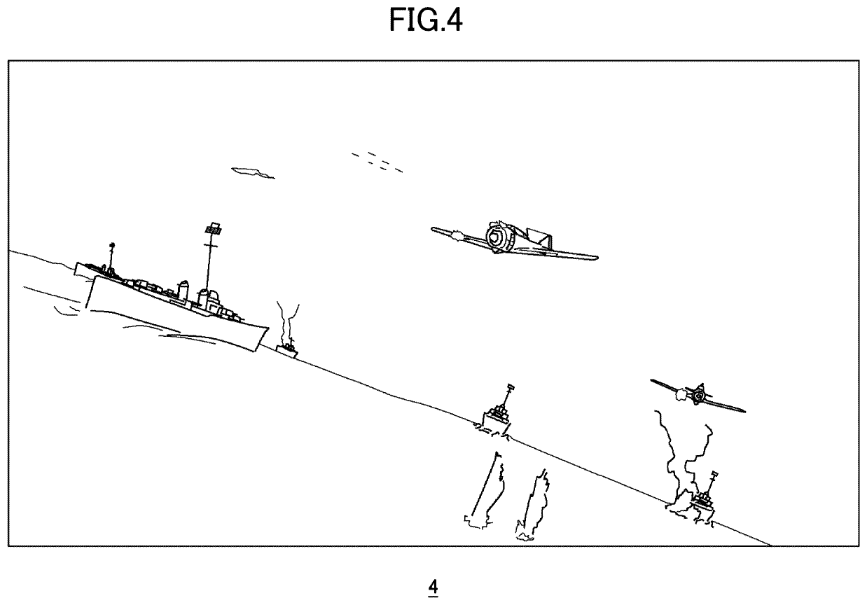

FIG. 4 shows an example of a game screen displayed on the output device 4. The user operates the input device 6 whilst viewing the game image, to play the game.

When an event occurs during a game in progress, the game program outputs event information indicating that the event occurred. When acquiring the event information from the game program, the event information acquisition part 118 adds, to the event information, the user account, the game ID, and the time information (time stamp) indicating the time of occurrence of the event, thereby generating event data, and the event information acquisition part 118 provides the event data to the sending processing part 122. The game program may also output event information including the game ID and/or the time stamp to the event information acquisition part 118. The sending processing part 122 sends the generated event data to the server device 5 via the communication part 102.

In the game program, the start and the end of an activity are coded as events. When starting an activity during a game in progress, the game program outputs event information indicating the occurrence of a starting event of the activity and, when the activity has ended, the game program outputs event information indicating the occurrence of an ending event of the activity. The game maker may set up various events in the game. For example, if a battle activity against an enemy boss is incorporated into the game, at the time of starting the battle, the game program outputs the activity ID for identifying the battle activity and event information including information which indicates the start of the battle activity. If the user wins the battle against the enemy boss, the game program outputs event information including the activity ID for identifying the battle activity, information indicating the end of the battle activity, and information indicating success of the activity.

The sending processing part 122 sends event data relating to the activity performed by the user to the server device 5 via the communication part 102. Since there are also events other than the activity, the sending processing part 122 also sends event data not relating to the activity to the server device 5. When having acquired event information from the game program, it is preferable that the event information acquisition part 118 immediately generates event data to which a time stamp is added, and that the sending processing part 122 sends the event data to the server device 5.

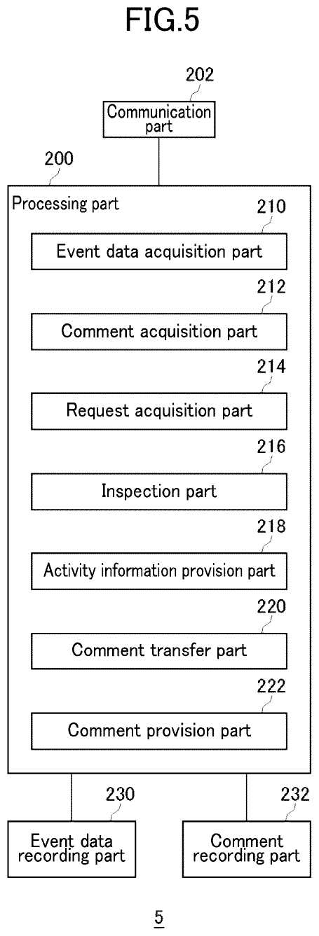

FIG. 5 shows function blocks of the server device 5 according to the embodiment. The server device 5 includes a processing part 200, a communication part 202, an event data recording part 230, and a comment recording part 232. The processing part 200 includes an event data acquisition part 210, a comment acquisition part 212, a request acquisition part 214, an inspection part 216, an activity information provision part 218, a comment transfer part 220, and a comment provision part 222.

The server device 5 includes a computer and the computer executes a program, so that the various functions shown in FIG. 5 are realized. The computer includes, as the hardware, a memory for loading the program, one or more processors for executing the loaded program, an auxiliary storage device, and other LSIs, etc. The processor is configured from a plurality of electronic circuits including a semiconductor circuit and LSI, and the plurality of electronic circuits may be mounted on one chip or on a plurality of chips. The function blocks shown in FIG. 5 are realized in cooperation between the hardware and the software, and thus the skilled person understands that these function blocks are realized in various forms, namely, by the hardware only, by the software only, or by a combination thereof.

The event data acquisition part 210 acquires, from the information processing apparatus 10, event data relating to an activity performed by the user and registers the event data in the event data recording part 230. The event data recording part 230 records the event data for every game title by linking the event data with the user account. As already explained, the event data includes at least the game ID, the activity ID, the information indicating the start or the end of the activity, and the time stamp. The information processing apparatus 10 sends the event data in real-time, so that the server device 5 can recognize the activity which is being performed or activity not yet performed by the user.

In the information processing system 1 according to the embodiment, after the user has performed an activity, he/she can enter a comment in relation to the activity in a predetermined input area to send it to the server device 5. The comment may be advice for the players who perform the activity, which may be, for example, something like “Beware of the suddenly appearing enemy.” The comment may also be an opinion addressed to game developers, such as “This activity was fun.” Hereinafter, it will be explained how the user enters a comment in relation to an activity.

### How to Enter a Comment

In the embodiment, the user enters a comment in relation to the activity from the save screen of the game. When a game in progress reaches a predetermined save point, the game image generation part 114 generates a save image, and the display processing part 120 displays the save screen on the output device 4. When the user also performs an operation to open the save screen from the input device 6, the display processing part 120 displays the save screen on the output device 4. Since the user can review his/her own play on the save screen, it can be said that the timing of displaying the save screen is a timing which is suitable for entering the comment in relation to the activity.

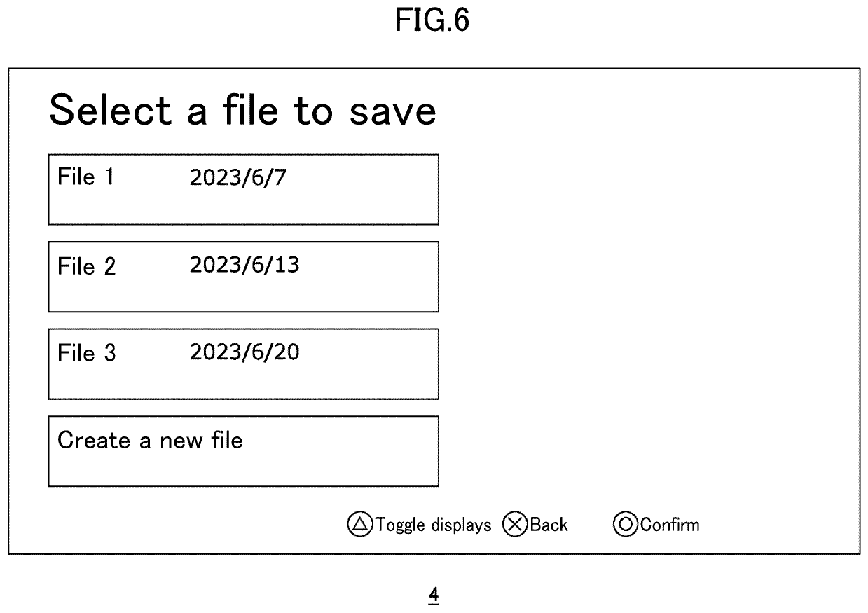

FIG. 6 shows an example of the save screen. When the user enters predetermined operation information from the input device 6 on the save screen of the game, the reception part 110 receives the predetermined operation information, and the activity information acquisition part 124 requests the server device 5 to provide information relating to the activity performed by the user. For example, when the user presses down a predetermined button (home button) of the input device 6 during the display of the save screen, the activity information acquisition part 124 may request that the information relating to the performed activity be provided.

In the server device 5, when having received an information provision request, the activity information provision part 218 provides, to the information processing apparatus 10 via the communication part 202, information relating to one or more activities performed by the user from the time of the previous save to the present save. It is assumed that the date of the previous save by the user is provided from the information processing apparatus 10 to the server device 5. In the information processing apparatus 10, the activity information acquisition part 124 acquires the information relating to the one or more performed activities, where the information is provided from the server device 5. The system image generation part 126 generates a system image including the information relating to the activity, and the display processing part 120 overlaps and displays the system image on the save screen.

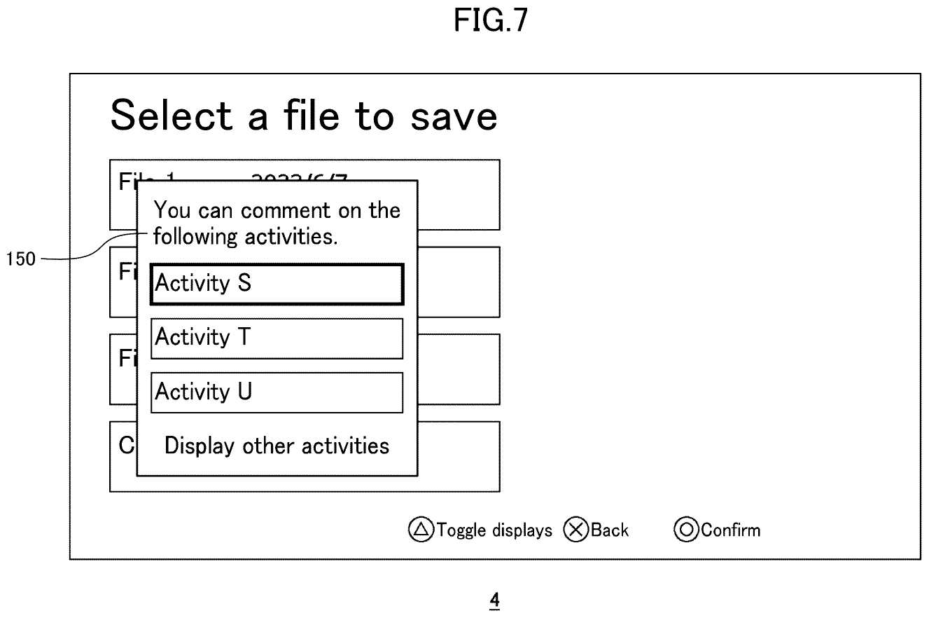

FIG. 7 shows an example of the system image overlapped and displayed on the save screen. The display processing part 120 displays a card-type system image 150 including information relating to one or more activities on which the user can enter a comment. The system image 150 is a GUI (graphical user interface) for notifying information relating to activities on which a comment can be entered and, in this example, an activity S, an activity T, and an activity U performed by the user are selectably displayed.

It is preferable that the information relating to the latest activity performed by the user is displayed on the system image 150. The activity information provision part 218 refers to content recorded in the event data recording part 230 to specify the latest activity performed by the user, and provides the information relating to the specified one or more activities to the information processing apparatus 10. Thus, the user can enter comments on the activities while his/her memory of the game play is still distinct. When the user selects the “Display other activities” area by means of the input device 6, the activity information acquisition part 124 may acquire information relating to the other activities from the server device 5, and the display processing part 120 may display the information relating to the other activities on the system image 150.

The user selects the activity on which he/she would like to enter a comment by means of the input device 6. In an example shown in FIG. 7, the activity names are indicated as the information relating to an activity; however, an explanation of the content of the activity may also be displayed. By displaying the explanations of the content of the activity, the user can easily specify the performed activity to easily select the activity.

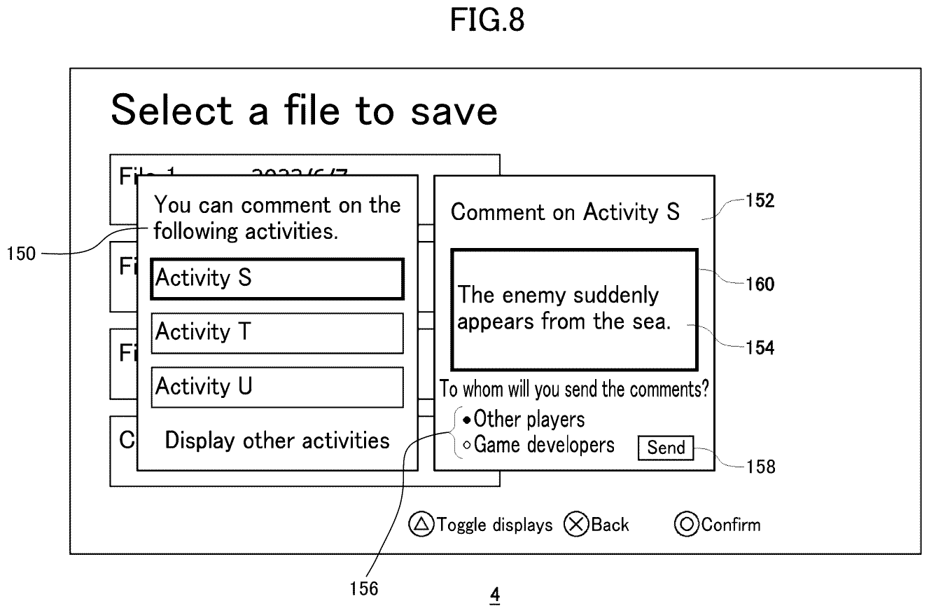

FIG. 8 shows another example of the system image overlapped and displayed on the save screen. When the activity S is selected in the system image 150, the system image generation part 126 generates a card-type system image 152 including an input area 154 where a comment in relation to the activity S can be entered, and the display processing part 120 overlaps and displays the system image 152 on the save screen. The user operates the input device 6 and can enter the comment in relation to the activity S in the input area 154. When the user adjusts a focus frame 160 to the input area 154, a software keyboard (on-screen keyboard) appears, so that the user can enter the text in the input area 154 by operating the software keyboard. In this example, the user enters the comment “The enemy suddenly appears from the sea” in the input area 154. The reception part 110 receives the comment to be entered in the input area 154 in relation to the activity S.

The user can post, in the input area 154, a link to a video of the activity S uploaded to a video-sharing site. At this time, meta information indicating the video of the activity S is preferably added to the video.

In the system image 152, an option of addressees 156 for the comment are displayed. The user sets the addressee 156 for the entered comment to either “Other players” or “Game developers.” If entering advice for other players in the input area 154, the user sets the addressee 156 to “Other players” and if entering feedback to the game developers in the input area 154, sets the addressee 156 to “Game developers.” The reception part 110 receives the selected addressee. While the comment shown in FIG. 8 is addressed to “Other players”, if addressing the comment to “Game developers”, the user may enter a comment such as “The gimmick in the sea was good” to state that the activity was good or not fun. When the user operates a sending button 158, the sending processing part 122 sends, to the server device 5, the comment entered in the input area 154 and the addressee together with the user account and the information for specifying the activity S.

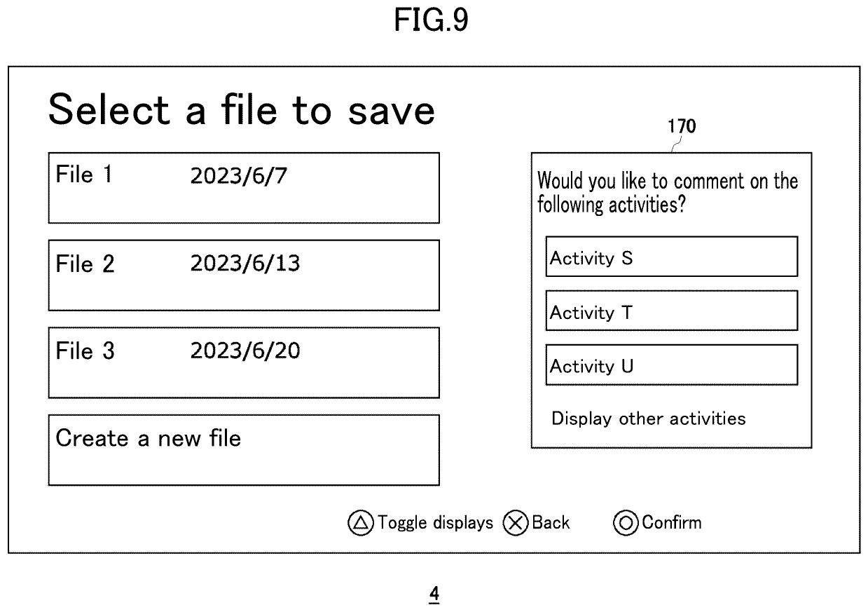

FIG. 9 shows another example of the save screen. The save screen shown in FIG. 9, which is different from the save screen shown in FIG. 6, has a list image 170 displayed on a part of the save screen, the list image 170 including information relating to one or more activities on which a comment can be entered. The game program recognizes the one or more activities performed by the user from the time of the previous save to the present save, and the game image generation part 114 can generate the list image 170 including the information relating to the latest performed activity. In this example, the activities S, T, and U performed by the user are displayed so that they can be selected. When the user selects the “Display other activities” area by means of the input device 6, the game image generation part 114 generates the list image 170 including the information relating to the other activities.

The user selects the activity on which he/she would like to enter a comment by means of the input device 6. In an example shown in FIG. 9, the activity names are indicated as the information relating to the activity; however, an explanation of the content of the activity may also be displayed. The explanation of the content of the activity is displayed so that the user can easily specify the performed activity to easily select the activity.

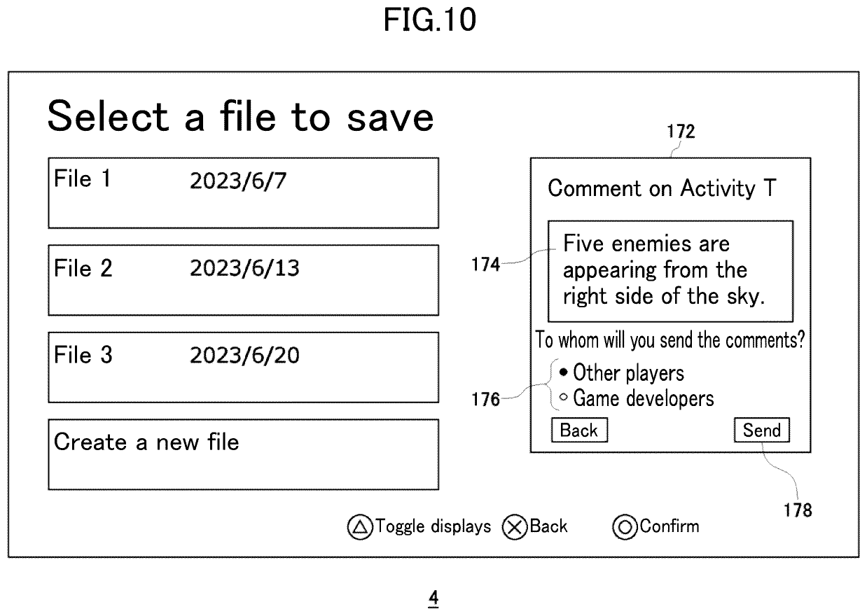

FIG. 10 shows another example of the save screen. When the activity T is selected in the list image 170, the game image generation part 114 generates an input image 172 including an input area 174 where a comment relating to the activity T can be entered, and the display processing part 120 displays the save screen, partially including the input image 172. The user operates the input device 6 and can enter the comment relating to the activity T in the input area 174. In this example, the user enters the comment “Five enemies are appearing from the right side of the sky” in the input area 174. The reception part 110 receives the comment to be entered in the input area 174 in relation to the activity T.

In the input image 172, an option of addressees 176 for the comment are displayed. The user sets the addressee 176 for the entered comment to either “Other players” or “Game developers.” If entering advice for other players in the input area 174, the user sets the addressee 176 to “Other players” and if entering feedback to the game developers in the input area 174, sets the addressee 176 to “Game developers.” The reception 110 receives the selected addressee. The comment shown in FIG. 10 is addressed to “Other players” and therefore “Other players” is selected as the addressee 176. When the user operates a sending button 178, the sending processing part 122 sends, to the server device 5, the comment entered in the input area 174 and the addressee together with the user account and information specifying the activity T.

In the server device 5, the comment acquisition part 212 acquires, from the information processing apparatus 10, the comment entered by the user in relation to the activity and the addressee, and records them in the comment recording part 232. The comment acquisition part 212 records the user account, the comment, and the addressee in the comment recording part 232 by associating them with the information specifying the activity (activity ID). Therefore, in the comment recording part 232, the comments entered by various users and the addressees are to be recorded in association with the activity IDs.

If the addressee is “Game developers”, the comment transfer part 220 transfers feedback comments relating to the activity to terminal devices of the game developers. The game developers can get to know the users'direct opinions by seeing the feedback comments, and can make use of them for development of the activity.

If the comments on the activity include links to videos, the inspection part 216 inspects the relevance of the videos with the activity concerned by referring to the meta information included in the videos. Specifically, the inspection part 216 inspects whether or not the meta information of the videos indicates the videos of the activity concerned. For example, if the comments on the activity S include video links to the activity S, the inspection part 216 determines that the video links are appropriate. Meanwhile, if the comments on the activity S include video links to an activity different from the activity S, the inspection part 216 determines that the video links are inappropriate. At this time, the inspection part 216 may delete the inappropriate video links from the comments. In order to allow the inspection part 216 to thereby inspect the relevance of the videos with an activity, it is preferable that the videos include the meta information specifying the activity.

The comments addressed to the other players, which are recorded in the comment recording part 232, are provided to users who are going to perform an activity anew, or to users who are currently performing the activity, and are used as the advice from preceding players.

### How to Read Comments

Next, it will be explained how the user reads the comments generated by other users in relation to an activity.

When the user enters predetermined operation information from the input device 6 during the game play, the reception part 110 receives the predetermined operation information, and the activity information acquisition part 124 requests the server device 5 to provide the information relating to the activity being currently performed and/or an unperformed activity. For example, when the user presses down a predetermined button (home button) of the input device 6, the activity information acquisition part 124 may request provision of the information relating to the activity being currently performed and/or the unperformed activity.

In the server device 5, when having received the information provision request, the activity information provision part 218 provides, to the information processing apparatus 10 via the communication part 202, the information relating to the activity being performed and/or activity not yet performed by the user. The activity information provision part 218 refers to the content recorded in the event data recording part 230 to specify the activity being performed and/or activity not yet performed by the user, and provides the information relating to the specified one or more activities to the information processing apparatus 10.

In the information processing apparatus 10, the activity information acquisition part 124 acquires information provided from the server device 5, the information relating to one or more activities being performed and/or unperformed activities. The system image generation part 126 generates system images including information relating to the activity, and the display processing part 120 displays the system images on the output device 4.

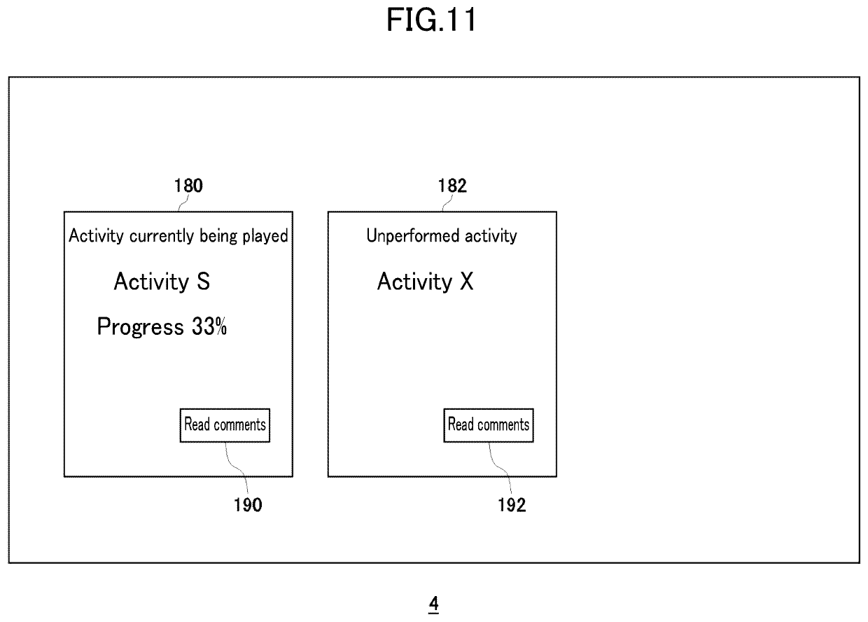

FIG. 11 shows an example of system images displayed on the output device 4. The system image generation part 126 generates system images 180 and 182 from the information acquired by the activity information acquisition part 124, and the display processing part 120 displays the system images 180 and 182 on the output device 4. During the game play, the display processing part 120 may overlap and display the system images 180 and 182 on the (not illustrated) game screen.

In the system image 180, there is displayed information 190 indicating that the activity S is being performed and that its progress is 33%, and that there are comments generated in relation to the activity S. In the system image 182, there is displayed information 192 indicating that the activity X is not yet performed, and that there are comments generated in relation to the activity X. When the user selects the “Read comments” area by means of the input device 6, the comment acquisition part 128 requests the server device 5 to provide the comments on the activity.

When the user selects the display area of the information 190 by means of the input device 6, the comment acquisition part 128 requests the server device 5 to provide comments on the activity S. In the server device 5, the comment provision part 222 retrieves the comments associated with the activity S from the comment recording part 232 and provides them to the information processing apparatus 10.

In the information processing apparatus 10, the comment acquisition part 128 acquires the comments provided from the server device 5. The system image generation part 126 generates a system image including the comments, and the display processing part 120 displays the system image on the output device 4.

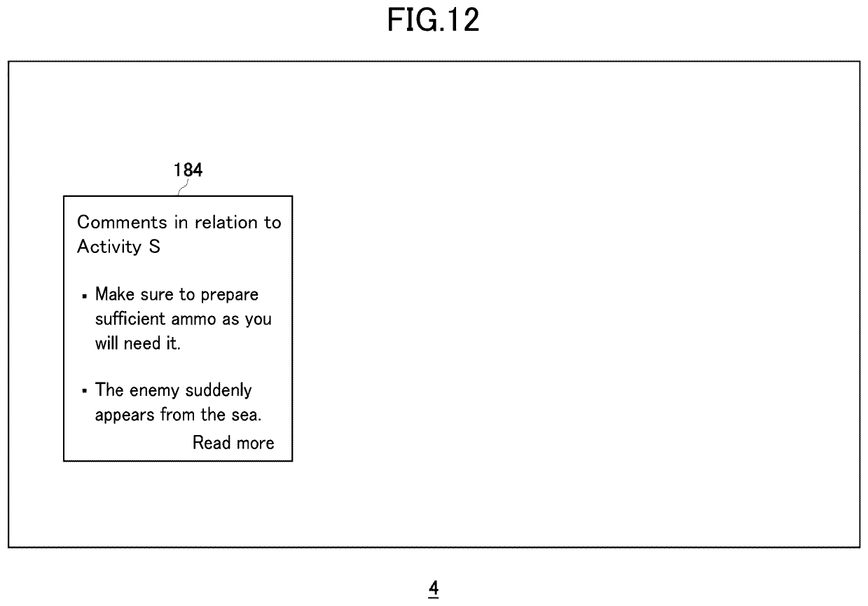

FIG. 12 shows an example of the system image displayed on the output device 4. The system image generation part 126 generates the system image 184 from the comments acquired by the comment acquisition part 128, and the display processing part 120 displays the system image 184 on the output device 4. In the system image 184, there are displayed the comments generated by other players in relation to the activity S. This allows the user to read the comments generated in relation to the activity, which is being performed or is not yet performed.

The users having read the comments can evaluate the comments generated by the other players. The evaluation values for the comments are sent to the server device 5, and the server device 5 may rank the comments by the plurality of players based on the evaluation values. This allows the comment provision part 222 to provide with priority the highly ranked comments to the users. If friends of the user generate the comments, it is preferable that the comment provision part 222 provides with priority the comments generated by the friends to the users. In this case, in the system images 180 and 182, information indicating that there are comments generated by the friends may be displayed.

The present disclosure has been explained so far based on the embodiment. This embodiment is an exemplification and it is understood by the skilled person that a variety of modified examples are allowable in combinations of the respective constituent elements and the respective processes of this embodiment, and that the modified examples are also within the scope of the present disclosure. In the embodiment, activities are presented as examples of play units; however, the play units may be trophies. Furthermore, the play units may also be configured from stages, quests, missions, tournaments, or sessions, etc. for which activities and trophies are not set.

In the embodiment, it is explained that the user enters comments relating to an activity at the time of displaying the save screen. In a modified example, the user may also enter the comments relating to the activity at another timing. For example, when the user ends the game play and sets the information processing apparatus 10 to an energy-saving mode, the system image generation part 126 may display a message, on the output device 4, inquiring whether a comment in relation to the play unit performed will be entered. When the user responds to the message at this time, the system image generation part 126 may display the system image 150, so that the user can enter the message relating to the activity.

The present disclosure can be used in the technical field where users can enter comments.

1 . . . Information processing system, 5 . . . Server device, 10 . . . Information processing apparatus, 100 . . . Processing part, 102 . . . Communication part, 110 . . . Reception part, 112 . . . Game execution part, 114 . . . Game image generation part, 116 . . . Game sound generation part, 118 . . . Event information acquisition part, 120 . . . Display processing part, 122 . . . Sending processing part, 124 . . . Activity information acquisition part, 126 . . . System image generation part, 128 . . . Comment acquisition part, 200 . . . Processing part, 202 . . . Communication part, 210 Event data acquisition part, 212 . . . Comment acquisition part, 214 . . . Request acquisition part, 216 . . . Inspection part, 218 . . . Activity information provision part, 220 . . . Comment transfer part, 222 . . . Comment provision part, 230 . . . Event data recording part, 232 . . . Comment recording part

1. An information processing apparatus, comprising:
one or more processors having hardware, wherein the one or more processors are configured to:
receive a comment to be entered in relation to a play unit performed by a user, and
send the comment together with information specifying the performed play unit.

2. The information processing apparatus according to claim 1, wherein the one or more processors are further configured to display an input area in relation to the play unit and display the comment received in the input area.

3. The information processing apparatus according to claim 2, wherein the one or more processors are further configured to display, on a save screen of a game, information in relation to one or more play units, to be associated with the comment.

4. The information processing apparatus according to claim 3, wherein the one or more processors are further configured to display the information in relation to the one or more play units, to be associated with the comment, when the one or more processors receive predetermined operation information from an input device while displaying the save screen of the game.

5. The information processing apparatus according to claim 2, wherein the one or more processors are further configured to inquire whether the comment in relation to the play unit performed will be entered, when the information processing apparatus transitions to an energy-saving mode.

6. The information processing apparatus according to claim 2, wherein the one or more processors are further configured to display one or more addressees for the comment.

7. An information processing apparatus, comprising:
one or more processors having hardware, wherein the one or more processors are configured to:
acquire information in relation to a play unit being performed by a user or a play unit not yet performed by the user; and
display, together with the information in relation to the play unit, information indicating that there is a comment in relation to the play unit.

8. The information processing apparatus according to claim 7, wherein the one or more processors are further configured to display the comment generated in relation to the play unit.

9. A method for sending a comment, comprising:
receiving a comment in relation to a play unit performed by a user, and
sending the comment together with information specifying the performed play unit.

10. The information processing apparatus of claim 1, wherein the one or more processors are configured to:
execute a game program comprising one or more activities in the play unit;
display a list of the one or more activities upon receipt of a save request; and
upon a receipt of a selection of an activity among the one or more activities, display an input area configured to receive the comment.

11. The information processing apparatus of claim 10, wherein the list of the one or more activities comprises one or more latest activities performed by the user.

12. The information processing apparatus of claim 10, wherein the one or more processors are further configured to display a save screen of a game at a save point, and
wherein the list of the one or more activities comprises the one or more activities performed by the user from a previous save point to the save point.

13. The information processing apparatus of claim 10, wherein the one or more processors are configured to receive the list of the one or more activities from a server upon reaching the save point.

14. The information processing apparatus of claim 10, wherein the input area is configured to receive a link to a video of the activity uploaded to a video-sharing site, comprising metadata.

15. The information processing apparatus of claim 6, wherein, upon a receipt of a selection of an addressee among the one or more addressees, the one or more processors are configured to send the comment, the addressee and an account information of the user to a server.

16. The information processing apparatus of claim 8, wherein the one or more processors are configured to:
display one or more comments in relation to the play unit provided by one or more information processing apparatuses comprising the comment;
receive one or more evaluation values for the one or more comments;
rank the one or more comments based on the one or more evaluation values; and
display the one or more comments associated with the play unit in accordance with the ranking.

17. The information processing apparatus of claim 16, wherein the one or more processors are further configured to prioritize the comments having higher rankings.

18. The information processing apparatus of claim 17, wherein the one or more processors are configured to:
identify, from among the one or more comments, a comment posted by another user who has a predetermined relationship with the user; and
display the comment posted by the other user with priority over other comments.

19. The information processing apparatus of claim 18, wherein the predetermined relationship comprises the user and the other user being friends in a gaming network.
